(19) United States
(12) Patent Application Publication
(10) Pub. No.: US 2013/0121194 A1
(43) Pub. Date: May 16, 2013

(54) Method and apparatus for locally optimizing wireless operation in mobile devices

(71) Applicant: Ardalan Heshmati, Saratoga, CA (US)

(72) Inventor: Ardalan Heshmati, Saratoga, CA (US)

(21) Appl. No.: 13/676,091

(22) Filed: Nov. 13, 2012

Related U.S. Application Data
(60) Provisional application No. 61/560,258, filed on Nov. 15, 2011.

(51) Int. Cl. H04W 52/02; H04W 24/02

(52) U.S. Cl. CPC H04W 52/0258; H04W 24/02
USPC 370/252; 370/311

(57) ABSTRACT

Location profile is used as a way of optimizing power consumption of communication devices such as mobile handsets and smart phones which tend to have facilities for multiple wireless methods for communication. This is done by correlating the availability of the wireless signals to the specific zones in the user location profile. The method learns the wireless environment of each zone and subsequently while the device is detected to be in the same zone, intelligently prioritizes use of different communication methods for that zone, and turns off all unnecessary communication options, thereby reducing power consumption.

This application claims priority to Provisional Application Ser. No. 61/560,258, filed Nov. 15, 2011, the content of which is incorporated by reference.

### BACKGROUND

The present invention pertains to a method and apparatus for locally optimizing wireless operation in mobile devices.

Many mobile devices such as smart phones have more and more options for wireless communication. This includes 2G/3G/4G cellular, WIFI, and Bluetooth. Optimal selection of the communication option to enable and use in a given location, leads to improved user experience at that location. It can include providing the most robust or fastest available option. It can also reduce power consumption by turning off all unnecessary circuitry and choosing most power efficient mode of operation for a given location. Many data plans offered by wireless operators offer capped monthly data limits over their cellular networks with incremental additional charges or significant reduction in data speed if user exceeds the monthly data limit. It is highly desirable to the user to avoid additional data coverage cost by conveniently utilizing other available free options where possible. As an example, most users with available trusted WIFI connectivity at home or workplace would rather use WIFI instead of cellular data when they are home or at work. In contrast, long battery life is also desired by the same users. As such, they prefer WIFI to automatically be enabled when at certain zones where they want to connect to trusted WIFI networks and otherwise turned off to conserve battery life.

As it stands, the mobile device doesn't have any a-priori information about where certain wireless options are available or deliver highest quality of service. As such, the mobile device scans the surrounding environment periodically, attempting in many cases unsuccessfully, to connect to cellular, WIFI, Bluetooth, and possibly other wireless networks and then do its best to utilize them. This periodic operation is repeated time and again even if certain wireless networks are previously determined not to be available and device has not moved into a different area where those signals could possibly be available again. This operation consumes significant unnecessary power, reducing device battery life.

This invention presents a method for optimizing the operation of the device in areas specific to user's location profile, where location profile is the collection of places the user frequently visits and occupies. It does so by characterizing the wireless signal availability and quality for all supported wireless radios for each location zone frequented by the user. This location specific characterization information is then used in subsequent visits to the same zone to provide key information about available wireless options in that zone, allowing the mobile device to quickly utilize the best to use and power down all others as appropriate. This eliminates the need by the mobile device to search for non-existing or sub-optimal networks and instead expedite acquisition and use of wireless signals that were previously determined to exist in a given zone.

### SUMMARY

Location profile can be used as a way of optimizing power consumption of communication devices such as mobile handsets and smart phones which tend to have facilities for multiple wireless methods for communication. This is done by correlating the availability of the wireless signals to the specific zones in the user location profile. The method learns the wireless environment of each zone and subsequently while the device is detected to be in the same zone, intelligently prioritizes use of different communication methods for that zone, and turns off all unnecessary communication options, thereby reducing power consumption.

People in everyday life tend to frequent many of the same locations. This includes significant time spent in frequently visited primary zones of interest such as home, work-place, school. Other locations are frequented but less regularly—secondary zones of Interest such as supermarket, mall, movie theaters, gas stations, local eateries and bars, etc. The locations frequented by any one user are individually termed as zones or location zones. The aggregate of zones specific to a user are collectively referred to as that user's location profile. Efficient user location profile determination is possible with technologies available in many of today's mobile devices. The location profile determination identifies the zones frequented by the user. The actual method for efficient location profile determination is disclosed in U.S. patent application Ser. No. 13/269,547, filed on Oct. 7, 2011, the content of which is incorporated by reference.

For any given zone, the zone wireless environment is learned. While mobile device is detected to be in a known zone, the mobile device scans for existence of all wireless systems the device is capable of receiving. This can include GSM and CDMA networks and various generations of these cellular networks (2G/3G/4G) and possibly different radio frequencies. it also includes WIFI and BT. In future it could also include other wireless options and future cellular generations. The existence or absence of all these signals is detected and stored in the Zone Wireless Characterization Summary (ZWCS) for that zone. For wireless networks where specific pairing and 1-to-1 connection is needed and may require options for security handshake, the successful connection by the device is noted. For example, the mobile device user may allow automatic WIFI connection to a specific WIFI network identified by name. If such a connection is successfully made in this zone, this information is detected and stored in the ZWCS for that zone.

In one embodiment, for all wireless networks that exist, quality of service indicators are collected. This may include but not limited to one or combination of the following: (1) signal to noise ratio (SNR) or average of multiple SNR observations, (2) data speed, (3) bit error rate, (4) power consumption to establish and maintain data link, (5) power consumption rate per bit of transmitted and received data.

For any zone, the full or partial learning process is executed periodically when mobile device is detected to be in that zone. The result is captured and combined with previously captured ZWCS.

Out-of-zone policy defines the behavior of the optimizer when the device is detected to be out of known zones. It can be used to optimize the performance of the device when it's in transit between known zones. As a example, some users don't use WIFI while in transit and on the move. As such, it would be appropriate to completely turn off WIFI functionality in this scenario. By turning off WIFI, the device conserves power consumed by the WIFI function which otherwise would unnecessarily scan the surroundings and attempt to associated with unauthorized/unfriendly WIFI access points.

The 3G networks are sparser in the US than desired. Even living on the outskirts of a major city can mean poor signal coverage. 4G is just now getting rolled out in major metropolitan cities and will continue to provide spotty coverage outside urban areas for some time to come. This incremental coverage will always be the case as new generations of wireless networks are deployed. While mobile devices are provided with some network coverage information intended to aid their network selection and signal search, this information is useful at the macro level and may not always adequately reflect the user's specific area of use such as home, work-place, or school. Even when signal is available, spotty coverage of newer generation of networks in certain areas may result in thrashing as the device struggles to communicate on one network and has to handoff to another and this is done repeatedly.

ZWCS entries are formed for each and every one of the zones in the user's location profile when that zone is visited. On subsequent visits to a zone, the ZWCS for that zone is used to intelligently prioritize use of different communication methods in each given zone, turn off unnecessary communication chains and thereby reduce power consumption.

For example, if 4G cellular coverage is consistently observed as being poor or non-existent within a given zone, the 4G functionality in the mobile device may be turned off completely to both conserve energy and also streamline device's operation by relying on radio signals available at higher quality of service, while the device in detected to be in that zone.

Mobile device is power optimized by utilizing the most appropriate device resources in a given zone or when device is out of zone. Wifi can provide faster data rate as compared to cellular. It also tends to have the best data rate to energy ratio. So when available, it is the desired connectivity option to use. On the other hand, it can consume a considerable amount of energy just scanning the WIFI band for available Access Points to connect to and many times, these are not free or trusted Access Points the user would want to use. With this invention, the WIFI is turned on only in zones where user has previously successfully connected to WIFI. Otherwise it's turned off to conserve energy. similarly, in zones where date connectivity is supported by WIFI, the cellular data capability and all the associated HW/SW functionality may be disabled or put into low power/idle mode to conserve energy.

Implementations of the above aspect may include one or more of the following.

Various aspects and embodiments of the invention are described in further detail below.

### BRIEF DESCRIPTION

The present invention described herein will become apparent from the following detailed description considered in connection with the accompanying drawings, which disclose several embodiments of the invention. It should be understood, however, that the drawings are designed for the purpose of illustration and not as limits of the invention.

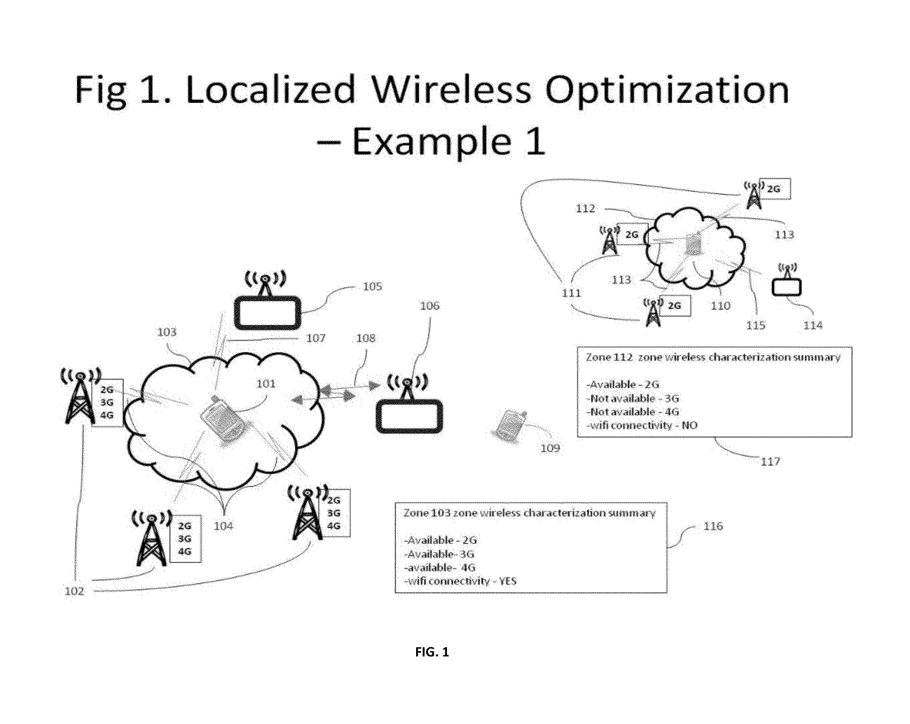

FIG. 1 shows a Localized Wireless Optimization example.

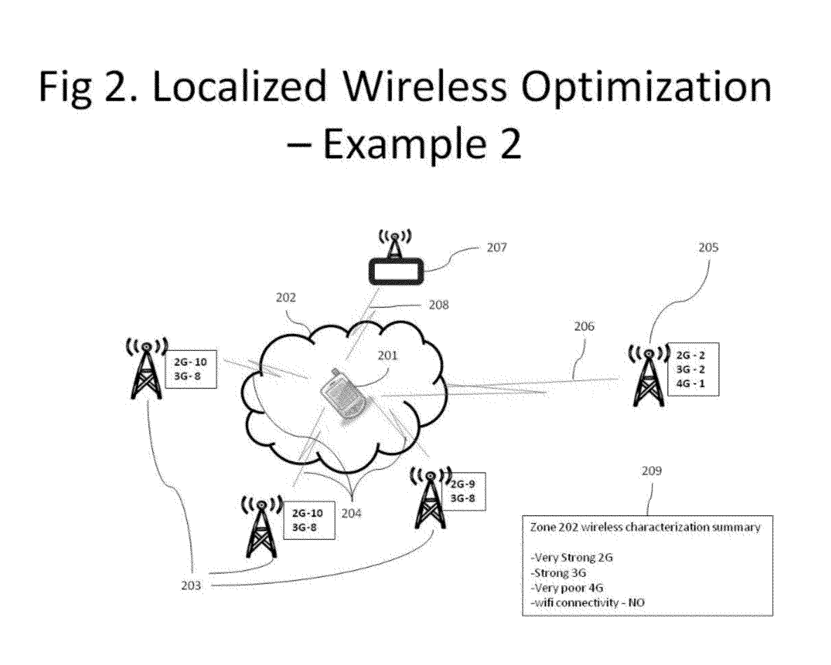

FIG. 2 shows another Localized Wireless Optimization example.

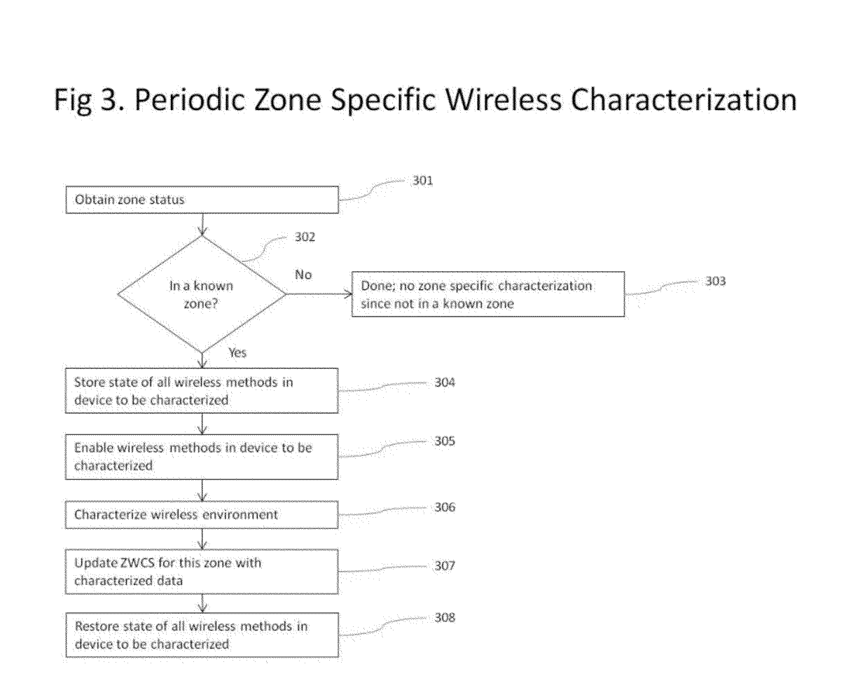

FIG. 3 shows an exemplary Periodic Zone Specific Wireless Characterization.

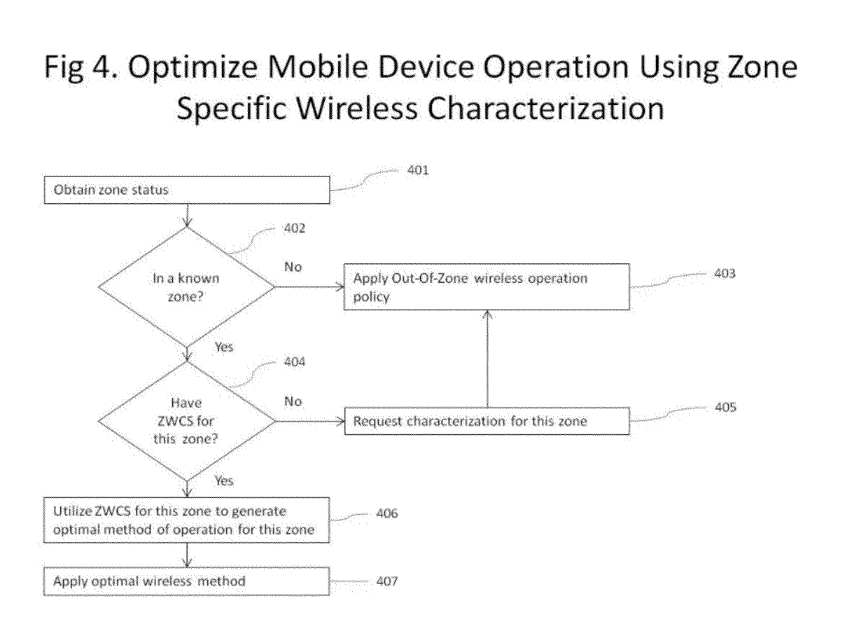

FIG. 4 an exemplary Optimizing Mobile Device Operation Using Zone Specific Wireless Characterization.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The system may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

FIG. 1 shows a Localized Wireless Optimization example. FIG. 1 illustrates a method for characterizing cellular and connectivity signals present in a given location zone. In this figure, mobile device (101) located in location zone (103), scans its surroundings for different radio signals the device is capable of receiving. In this example, the device is able to receive signals (104) from the 3 cellular base stations (102), where these base stations are all capable of operating 2G, 3G, and 4G networks. The device is also capable of receiving signal and establishing connection (108) to WIFI access point (106). It is additionally able to receive signal (107) but not able to establish connection to the WIFI access point (105). The mobile device catalogs all available radio signals it is able to receive and use in zone (103) and stores it in the ZWCS for that zone (116). The summary for this zone indicates 2G/3G/4G networks as being available, and WIFI connectivity also being available.

Subsequently, when device (102) is detected to be in location zone (103), the ZWCS for this zone (116) is used to prioritize wireless technologies to use and which ones to power down if not absolutely required. In this example, the device may opt to disable 3G/4G cellular data capability in favor of using the available WIFI connectivity for data transmission and reception. Wifi tends to be more power efficient. A WIFI connnection can also help reduce cost as many cellular network operators are now offering data plans with monthly data limits in addition to talk time limits.

In one embodiment, for zones typically occupied for extended durations at a time, this could also be used as a trigger to switching off cellular completely and rely solely on WIFI for both data and voice using Voice Over IP (VOIP) technology. Doing so would help the user by conserving the user's limited monthly talk minutes. It would also help the carrier by offloading some load from their network or augmenting the network with poor coverage in that area.

Mobile device (110), which may be the same mobile device as (101), located in a different location zone (112), similarly scans its surroundings. In this zone, the device is able to receive signals (113) from the 3 cellular base stations (111), where these base stations are all only capable of 2G operation. In this zone, even though the device is also receiving signal (115) from WIFI access point (114), it is not able to fully connect to that access point. This could be for a variety of reasons including the device not having the proper security authorization. The mobile device catalogs all available wireless signals it is able to receive and use in zone (112) and store it as the ZWCS for this zone (117). The summary for this zone indicates 2G networks being available, 3G/4G not being available, and WIFI connectivity not being available.

Subsequently, when device (110) is detected to be in location zone (112), the ZWCS for this zone (117) is used to prioritize wireless technologies to use and which ones to power down if not absolutely required. In this example, the device may opt to enable 2G, disable 3G/4G cellular chains completely, in addition to also disabling WIFI.

The process of characterization is repeated periodically when device is in a zone to ensure the zone wireless characterization summary correctly reflects the latest surrounding wireless environment and captures any changes to the wireless networks including addition or deletion of nodes such as cellular base stations or WIFI access points. The periodicity could be determined by a number of factors including but not limited to an event where the device is detected to be plugged to a power source, some prescribed time interval, or where ZWCS for the same zone obtained from another source is sufficiently different from that maintained within the mobile device. Another source could be another device or an aggregating ZWCS server combining ZWCS reports for the same zone from multitude of devices.

This system allows the mobile device to conserve a significant amount of energy by fine-tuning the wireless operation of the device, tailored to the wireless environment of each visited zone, where wireless characteristics are captured in the ZWCS for each zone. The alternative, as typically implemented by mobile devices require the device to repeatedly search for available signals and networks, thereby consuming significant amount of power and reducing battery life.

This technique applies equally to all variants of cellular networks such as GSM and CDMA and the subsequent variants and current and future generations. it is also not limited to cellular and WIFI. It can apply to Bluetooth and can equally apply to any other wireless technology present in mobile devices whose frequent usage can be correlated to specific zones in a meaningful way.

In this figure, mobile device (109) in detected to be on the move and outside of any known zone. In this scenario, the out-of-zone policy is applied. Certain technologies lend themselves well to use on the move, such as Bluetooth. Others seldom lend themselves to use while on the move, such as WIFI. The out-of-zone policy is used to specify how the mobile device should enable or disable various wireless capabilities while the device is detected to be outside of known zones to allow for best user experience while still conserving energy. As an example, if WIFI is only intended to be used in known zones, turning WIFI off while on the go, can result in significant power reduction without any impact to performance.

FIG. 2 illustrates another example of localized wireless characterization and optimization. The mobile device (201) is determined to be in location zone (202). As it scans the surroundings, it is able to receive signals (204) from cellular base stations (203) capable of 2G/3G network operation. The signal level received for each base station is indicated next to the xG label as an arbitrary measurement unit (AMU) between (0-10), where 10 is best and 0 is worst. The device is also able to receive signals (206) from base station (205) which is capable of 2G/3G/4G operations but the device is receiving very low signal levels (1-2 AMU) from this base station. Finally, the device is able to receive signal (208) from WIFI access point (207) but unable to connect to it.

In one embodiment, in addition to what signals are available in a zone, other signal characteristics are also captured and stored in the ZWCS for that zone and used for future decision making. In this case, signal level from each base station is additionally captured, and an aggregate measure of goodness for each network is formed. Other characteristics that may be optionally considered include but not limited to effective data transmission speed, bit error rate, power consumption to establish and maintain data link, and power consumption per bit transmitted/received.

Based on observations by the mobile device (201) while in location zone (202), the ZWCS for zone (202) is captured and stored (209), which indicates strong to very strong signal level on 3G and 2G, very poor signal level on 4G, and no WIFI connectivity.

Later, when mobile device is detected to be in zone (202), the zone's ZWCS (209) is used to decide best mode of connectivity for the device while in that zone. Based on this information, the mobile device disables and powers down all unavailable and poor quality connections which in this case include WIFI and 4G. It will utilize 3G and 2G networks in some prescribed priority.

In one embodiment, the zone wireless characterization summary may be viewed and actions from it may be partially or fully overridden by the user to allow the user ultimate control on how to operate the various available wireless options.

In another embodiment, feedback is provided back to the user or network operator on how to further optimize the operation of the wireless mobile device for high frequency zones to improve coverage and optimize operation. In the case of zone (202), the feedback could include (1) provisioning of the mobile device to connect to existing WIFI access point (207), (2) deployment of additional WIFI access point that the mobile device can connect to, (3) deployment of additional 4G base stations to better cover the area including zone (202), (4) deploy a 4G small area coverage cellular base station, such micro-cell or femtocell, to specifically improve 4G cover in zone (202).

In one embodiment, the zone wireless characterization summary for a given zone learned by one device may be shared directly or indirectly via a central function, such as a aggregating server, to a 2nd device and then used by the 2nd device to optimize its wireless operation when in that zone.

In one embodiment, the detailed information about all the cellular signals received in a given zone is captured and stored in the ZWCS for that zone. For each signal, this could include but not limited to the unique identifier of the broadcast point, signal search parameters including signal center frequency, average signal level and bit error rate. In subsequent visits, this information is then utilized by the appropriate cellular processing function in the mobile device to prioritize and expedite search and acquisition of the associated cellular signals. The same approach may be taken for all other wireless signals as well.

FIG. 3 shows an exemplary Periodic Zone Specific Wireless Characterization. This flow chart highlights the steps involved in characterizing the relevant wireless signals and networks specific to a given zone when visited by the mobile device. The relevant wireless signals and networks are those that the mobile device supports. In the case of modern smart phones this includes but not limited to 2G/3G/4G cellular networks, WIFI, and Bluetooth.

As a first step, the status of whether the device is in a zone is obtained (301). If not in a known zone (302), then no further action taken as the device is most likely on the move and any characterization cannot be associated with a specific zone.

if device is detected to be in a known zone (302), the method will continue with the characterization process. It will first store the state of all wireless methods to be characterized (304) to allow for restoring to the original settings later (308). All methods of operation to be characterized are turned on and enabled (305). Signals from all wireless methods of interest are characterized (306) and captured in the Zone Wireless Characterization Summary (ZWCS) for this zone (307). Steps (305), (306), and (307) may be performed sequentially one at a time for each wireless signal of interest or performed simultaneously in parallel for all signals of interest. The actual characterization is discussed in more detail in FIGS. 1 and 2. Finally, the state of all wireless methods characterized is reset (308) to what it was prior to characterization.

This approach allows for learning of the wireless environment and associating that learning specifically with the location zone where the characterization was collected.

In one embodiment, the large area wireless network coverage map can be used to look up expected coverage for the zone of interest. This information may then be used as as sole determinant of signal availability in that locale. It can also be used as additional input to the characterization process and combined with local observation. The coverage map may be obtained from an external entity such as a server. The information may be provided to the device for wireless network in its entirety or provide for the region relevant to the user's location profile or finally for one zone at a time. As an example, if the coverage map indicates that 4G cellular is not available in the zone being characterized, the 4G characterization may be skipped and 4G marked as unavailable in ZWCS for this zone.

In another embodiment, the ZWCS from mobile device may be submitted to an aggregating server which can compile submissions from multiple users to form a large area wireless network coverage which can in future be obtained and used by same or other mobile devices.

FIG. 4 an exemplary Optimizing Mobile Device Operation Using Zone Specific Wireless Characterization. This flow chart highlights the steps involved in applying the previously learned Zone Wireless Characterization Summary (ZWCS) for a given zone to optimize future operation of the device when it's detected to be in that zone.

As a first step, the status of whether the device is in a known zone is obtained (401). If device is detected not to be in a known zone (402), then the device is on the move or possibly in a not yet characterized zone. If this is the case, the out-of-zone policy is applied and the mobile device's wireless methods are configured to prescribed settings to yield optimal power consumption and functionality available to the user(403). For example, this could include disabling certain wireless methods which are typically not used on the go, such as WIFI or WIMAX, among others. It could also include enabling and holding in ready-state certain wireless methods that have high likelihood of being used by the user while on the move, such as Bluetooth or cellular data via 2G/3G data.

If mobile device is detected to be in a known zone (402), then the ZWCS data base is searched for entry related to the current zone. If valid ZWCS information for this zone doesn't exist (404), then request is made to perform wireless characterization for this zone (405) per FIG. 3. If valid ZWCS information for this zone exists, this information is utilized to generate optimal method of operation for this zone (406). This includes deciding what wireless communication methods in the mobile device to turn on and enable, which ones to turn off completely, and which ones to turn on but keep in lower power standby as possible fail over if the primary intended communication method is not successful. An example would be when in a given zone, the optimal operation implies using WIFI as primary option for data connectivity in a zone and 3G celluar data is maintain in standby to ensure smooth data connection is available in case of connection failure over WIFI.

Finally the mobile device hardware is commanded to apply optimal wireless method (407) to implement the optimal method decided in (406).

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments. Thus, the present invention is not intended to be limited to the embodiments shown herein but is to be accorded the widest scope consistent with the principles and novel features disclosed herein.

What is claimed is:

1. A method for minimizing power consumption of a mobile device, comprising:
determining an aggregate of zones frequented by a user as a user's location profile;
learning a wireless environment of each zone;
subsequently, while the mobile device is detected to be in one of the predetermined zones, prioritizing use of different communication methods for the predetermined zone; and
disabling unnecessary communication options to reduce power consumption.

2. The method of claim 1, comprising correlating the availability of wireless signals to specific zones in the user location profile.

3. The method of claim 1, wherein the zones comprise a primary zone including home, work-place, school and a secondary zone including supermarket, mall, movie theaters, gas stations, local eateries and bars.

4. The method of claim 1, wherein learning the wireless environment comprises scanning for wireless systems the mobile device is capable of receiving.

5. The method of claim 4, wherein the wireless systems cover WIFI, Bluetooth, GSM and CDMA networks and generations of these cellular networks (2G/3G/4G/5G) radio frequencies.

6. The method of claim 1, wherein the existence or absence of wireless signals is detected and stored in a Zone Wireless Characterization Summary (ZWCS) for that zone.

7. The method of claim 7, comprising storing pairing or access password in the ZWCS.

8. The method of claim 1, comprising capturing quality of service indicators in each zone.

9. The method of claim 8, comprising capturing signal to noise ratio (SNR) or average of multiple SNR observations, data speed, bit error rate, power consumption to establish and maintain data link, power consumption rate per bit of transmitted and received data.

10. The method of claim 1, comprising specifying an out-of-zone policy to define mobile device behavior when the device is detected to be out of known zones.

11. A system to reduce power consumption of a mobile device, comprising:
one or more transceivers to determine an aggregate of zones frequented by a user as a user location profile and to learning a wireless environment of each zone;
a mobile device in communication with one of the transceivers, wherein the mobile device detects a predetermined zone and prioritizes use of different communication methods for the predetermined zone, and disables unnecessary communication options to reduce power consumption.

12. The system of claim 11, comprising means for correlating the availability of wireless signals to specific zones in the user location profile.

13. The system of claim 11, wherein the zones comprise a primary zone including home, work-place, school and a secondary zone including supermarket, mall, movie theaters, gas stations, local eateries and bars.

14. The system of claim 11, comprising means for scanning for wireless systems the mobile device is capable of receiving.

15. The system of claim 14, wherein the wireless systems cover WIFI, Bluetooth, GSM and CDMA networks and generations of these cellular networks (2G/3G/4G/5G) radio frequencies.

16. The system of claim 11, wherein the existence or absence of wireless signals is detected and stored in a Zone Wireless Characterization Summary (ZWCS) for that zone.

17. The system of claim 17, comprising means for storing pairing or access password in the ZWCS.

18. The system of claim 11, comprising means for capturing quality of service indicators in each zone.

19. The system of claim 18, comprising means for capturing signal to noise ratio (SNR) or average of multiple SNR observations, data speed, bit error rate, power consumption to establish and maintain data link, power consumption rate per bit of transmitted and received data.

20. The system of claim 11, comprising s means for specifying an out-of-zone policy to define mobile device behavior when the device is detected to be out of known zones.
